(19) United States
(12) Patent Application Publication
(10) Pub. No.: US 2011/0226219 A1
(43) Pub. Date: Sep. 22, 2011

(54) FUEL LUBRICATED PUMP AND COMMON RAIL FUEL SYSTEM USING SAME

(75) Inventor: Alan Stockner, Metamora, IL (US)

(73) Assignee: CATERPILLAR INC., Peoria, IL (US)

(21) Appl. No.: 12/725,856

(22) Filed: Mar. 17, 2010

(51) Int. Cl. F02M 69/46; F02M 37/04; F16C 33/04

(52) U.S. Cl. 123/456; 123/495; 384/280

(57) ABSTRACT

A method of operating a fuel system for a compression ignition engine includes supplying biofuel, which may be part of a mixture, to an inlet of a fuel lubricated pump. At least one bearing of the pump is lubricated with the biofuel. The fuel lubricated pump supplies high pressure fuel to a common rail. A plurality of fuel injectors are fluidly connected to the common rail, and each include at least one nozzle orifice for injecting the biofuel into the combustion space of the engine. Nozzle orifice coking is limited at least in part by employing a spinodal bronze alloy in the bearing of the fuel lubricated pump.

### TECHNICAL FIELD

The present disclosure relates generally to high pressure fuel lubricated pumps for common rail fuel systems, and more specifically to a method of limiting nozzle outlet coking due to fuel degradation.

### BACKGROUND

Nozzle coking, in the context of fuel injection systems for compression ignition engines, refers to the build up of solids in the nozzle outlets of fuel injectors. Nozzle outlet coking can reduce the flow area through a given nozzle orifice, and hence alter intended fuel quantities to be delivered to a given engine cylinder. In extreme cases, nozzle coking can completely block a nozzle outlet, further complicating engine fueling problems. While the issue of nozzle outlet coking is not new, the problems associated with potential nozzle coking have become more uncertain as the usage of non-petroleum based fuels, such as biofuel, have become more widespread. For instance, SAE Technical Paper Series 2007-01-0073 recognizes that the interaction of biofuel with certain metals, such as copper, can accelerate fuel degradation.

The present disclosure is directed toward one or more problems set forth above.

### SUMMARY OF THE DISCLOSURE

In one aspect, a method of operating a fuel system includes supplying biofuel to an inlet of a fuel lubricated pump. At least one bearing of the pump is lubricated with the biofuel. The biofuel is moved from the pump toward a fuel injector and then injected from nozzle orifices of the fuel injector. Nozzle orifice coking is limited at least in part by employing a spinodal bronze alloy in the pump bearing.

In another aspect, a fuel lubricated pump includes at least one movable component positioned in a pump housing that defines an inlet. The at least one movable component is supported by at least one bearing, which is positioned to contact fuel entering the fuel inlet. Chemical interaction between biofuel and the bearing is limited by employing a spinodal bronze alloy in the bearing.

In still another aspect, a fuel system includes a fuel lubricated pump with an inlet fluidly connected to a source of biofuel. The fuel lubricated pump includes at least one bearing in contact with biofuel moving through the pump. A common rail has an inlet fluidly connected to an outlet of the fuel lubricated pump. A plurality of fuel injectors are fluidly connected to respective outlets of the common rail. A spinodal bronze alloy is employed in the bearing of the pump as a means by which nozzle orifice coking can be limited.

### BRIEF DESCRIPTION OF THE DRAWINGS

FIG. 1 is a schematic view of a fuel system according to one aspect of the present disclosure;

FIG. 2 is a sectioned side view through the fuel lubricated pump of the fuel system shown in FIG. 1; and

FIG. 3 is an exploded view of the fuel lubricated pump from the fuel system of FIG. 1.

### DETAILED DESCRIPTION

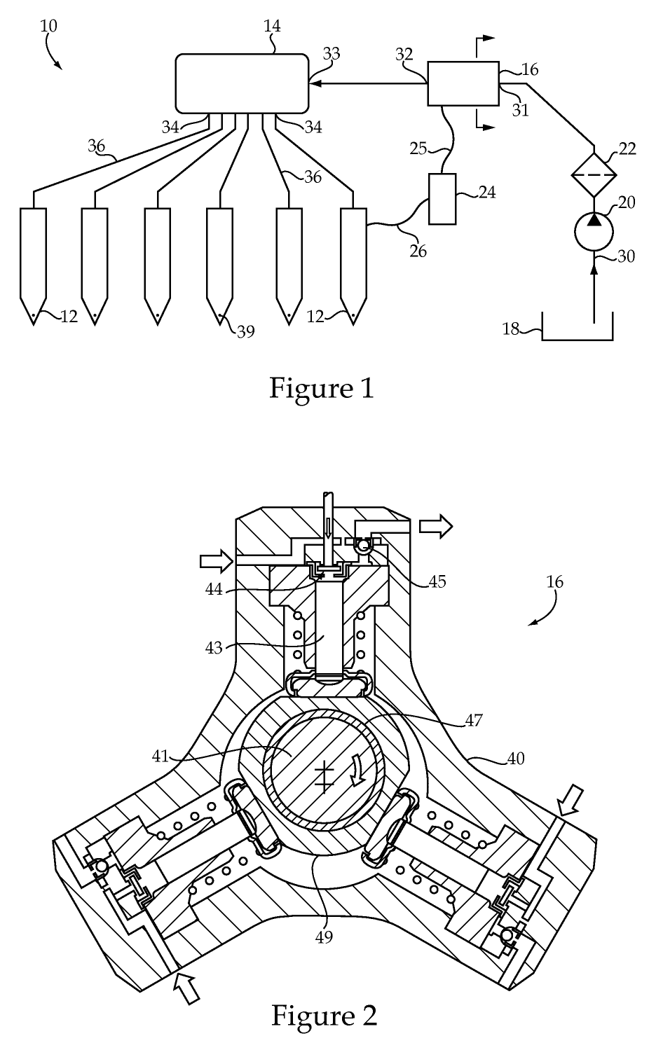

Referring now to FIG. 1, a common rail fuel system 10 includes a plurality of fuel injectors 12 fluidly connected to a common rail 14. In particular, common rail 14 includes a plurality of outlets 34 that facilitate fluid connection to individual ones of the fuel injectors 12 via individual branch passages 36. Each of the fuel injectors 12 includes one or more nozzle outlet orifices 39, which may be positioned for direct injection into the combustion space of a compression ignition engine (not shown). The inlet 33 of common rail 14 is fluidly connected to an outlet 32 of a high pressure fuel lubricated pump 16. A fuel transfer pump 20 has an inlet fluidly connected to a source of fuel 18 via a supply passage 30. The fuel transfer pump 20 pushes fuel through a filter 22 on its way to an inlet 31 of high pressure fuel lubricated pump 16. The fuel system 10 is controlled in its operation via an electronic controller 24 which is in control communication with pump 16 via communication line 25, and in control of fuel injectors 12 via communication lines 26, only one of which is shown. The source of fuel 18 may contain any suitable fuel for burning in a compression ignition engine including but not limited to petroleum based distillate diesel fuel and/or biofuel. The term “biofuel” refers to fuel having an origin from something other than petroleum. For instance, biofuels are often based upon plant products, animal fats and waste grease. In practice, one could expect a fuel injector to be supplied with biofuel that is only a minority constituent of a mixture that is predominantly distillate diesel fuel.

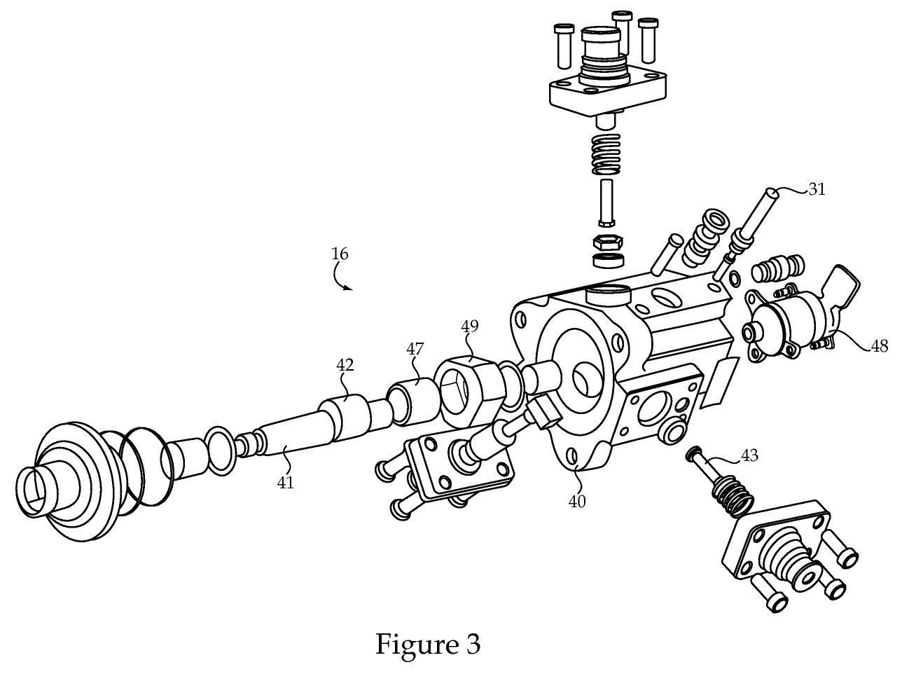

Referring now to FIGS. 2 and 3, high pressure fuel lubricated pump 16 may include a cam shaft 41 that may be driven directly by the engine. Mounted on, or formed as part of cam shaft 41, is at least one cam 42 that rotates to cause reciprocation of respective pump plungers 43 in a known manner. As each pump plunger 43 reciprocates toward the center of cam shaft 41, fresh fuel is drawn into a pumping chamber past a respective inlet check valve 44. When the plunger 43 is driven away from the center of cam shaft 41 due to a cam lobe interacting with pump plunger 43, pressurized fuel is pushed past an outlet check valve 5 in a known manner. The cam shaft 41 is supported for rotation by a bearing 42, which is best seen in the exploded view of FIG. 3. In the illustrated pump, bearing 47 functions as a bushing supporting the cam ring 49. Pump 16 also includes an inlet throttle valve 48 that acts as the means by which the output from the pump can be controlled. In other words, by throttling fuel supply at the inlet, the output from pump 16 can be controlled, and hence controlling the pressure in common rail 14 in a well-known matter.

For a variety of reasons, engineers have come to prefer the use of copper-based alloys in bearing components of fuel lubricated pumps of the type typified in FIGS. 1-3. However, the present disclosure recognizes that, with the increased wide-spread use of biofuel, there is a risk of fuel degradation due to chemical interaction with certain metals. Copper may possibly be among the worst with regard to degrading fuel that contacts and chemically interacts with the copper. Fuel degradation due to chemical interactions between biofuel and copper, for instance, can reveal itself as increased nozzle outlet orifice coking In other words, if fuel lubricated pump used a conventional copper alloy in the construction of bearing 47, one could expect the nozzle outlet orifices 39 of fuel injectors 12 to potentially coke up and become blocked, maybe in a mere matter of hours. The detrimental effects of biofuel are still evident when biofuel is mixed with distillate diesel fuel, which may be in the majority in a typical commercially available mixture.

The present disclosure teaches limiting such fuel degradation due to a chemical interaction between fuel lubricated bearing(s) of pump 16 by employing spinodal bronze in bearing 47. By using a spinodal bronze alloy, the bearing retains most of the advantages associated with a copper based bearing in the fuel lubricated pump 16, but accomplishes its bearing task with limited chemical interaction between the copper of the alloy and the biofuel. This limited chemical interaction drastically reduces fuel degradation typically associated with the chemical interaction between biofuel and copper, rendering concerns with regard to nozzle coking with the use of biofuels less than the concerns would be if conventional fuel lubricated copper alloy bearing(s) were used in pump 16. Thus, the means by which chemical interaction between biofuel and the bearing is limited is accomplished by forming the bearing 47 out of a spinodal bronze alloy. For reasons not completely understood, the copper of the spinodal bronze alloy tends to be less reactive with biofuel than nonspinodal bronze alloys, which are also predominately copper like all bronze alloys. One specific spinodal bronze alloy composition includes nickel in the range of 14.5 to 15.5 percent, tin in the range of 7.5 to 8.5 percent, lead in amount less than 0.02 percent, with the balance of the composition being copper. The only current known source for this alloy is Brush Wellman Inc. which is headquartered in Cleveland, Ohio.

### INDUSTRIAL APPLICABILITY

The present disclosure finds potential application in any metallic component that may come in contact with biofuel. The present disclosure finds specific application as an alternative to conventional copper alloys utilized in bearings for fuel lubricated pumps in common rail fuel systems. Potential problems associated with nozzle coking of nozzle outlet orifices of fuel injectors can be limited by the employment of spinodal bronze alloys in those components that may come in contact with biofuel somewhere in the fuel system. One specific place where this could occur is in one or more bearings of a fuel lubricated pump that supplies pressurized fuel to a common rail. For instance, the spinodal bronze alloy of the present disclosure may make a good replacement for traditional beryllium copper in fuel system applications. It may also be recommended in bearing applications where a high PV value is needed for sleeve bearing, which makes it a good choice for difficult sleeve bearing applications. The spinodal bronze alloy of the present disclosure is also noted for its corrosion resistance and excellent anti-gulling properties apart from its ability to limit nozzle coking that might otherwise occur utilizing traditional beryllium copper or other copper alloy bearing materials. In general, the spinodal bronze alloy of the present disclosure may not be the best selection for applications with continuous operating temperatures above 260° C.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A method of operating a fuel system, comprising the steps of:
supplying biofuel to an inlet of a fuel lubricated pump;
lubricating at least one bearing of the pump with the biofuel;
moving the biofuel from the pump toward a fuel injector;
injecting the biofuel from nozzle orifices of the fuel injector; and
limiting nozzle orifice coking at least in part by employing a spinodal bronze alloy in the bearing.

2. The method of claim 1 including rotating a cam shaft of the fuel lubricated pump in the bearing.

3. A fuel lubricated pump comprising:
a pump housing defining a fuel inlet;
at least one movable component positioned in the pump housing;
the at least one movable component being supported by at least one bearing, which is positioned to contact fuel entering the fuel inlet;
means, including employment of a spinodal bronze alloy in the bearing, for limiting chemical interaction between biofuel and the bearing.

4. The fuel lubricated pump of claim 3 wherein the at least one bearing includes a bushing.

5. The fuel lubricated pump of claim 4 wherein the bushing is positioned around a cam shaft.

6. A fuel system comprising:
a source of biofuel;
a fuel lubricated pump with an inlet fluidly connected to the source of biofuel, and including at least one bearing in contact with biofuel moving through the pump;
a common rail with an inlet fluidly connected to an outlet of the fuel lubricated pump;
a plurality of fuel injectors fluidly connected to respective outlets of the common rail; and
means, including employment of a spinodal bronze alloy in the bearing, for limiting nozzle orifice coking

7. The fuel system of claim 6 wherein the at least one bearing includes a bushing.

8. The fuel system of claim 7 wherein the bushing is positioned around a cam shaft.
